(19) United States
(12) Patent Application Publication
(10) Pub. No.: US 2006/0166169 A1
(43) Pub. Date: Jul. 27, 2006

(54) Fixture for orthodontic anchorage and osseo distraction of the alveolar process, and for the stabilization of temporary prostheses

(75) Inventor: Andrew J.S. Dawood, London (GB)

Correspondence Address: CONNOLLY BOVE LODGE & HUTZ LLP, SUITE 800, 1990 M STREET NW, WASHINGTON, DC, 20036-3425, US

(73) Assignee: Nobel Biocare AB (publ), Goteborg (SE)

(21) Appl. No.: 10/506,632

(22) PCT Filed: Mar. 6, 2003
(86) PCT No.: PCT/IB03/00822

§ 371 Date: Jun. 30, 2005

(30) Foreign Application Priority Data
Mar. 6, 2002 (GB) 02 05299.1
Jan. 21, 2003 (GB) 0301348.9

(51) Int. Cl. A61C 8/00

(52) U.S. Cl. 433/174

(57) ABSTRACT

The invention relates to a fixture for orthodontic and osseo distraction of the alveolar process, and for the stabilization of temporary prostheses. The fixture has an external threading, compromising a treaded part for insertion into a prepared site in the jawbone, and a treaded part, to which pressure may be applied by means of an internally threaded element e.g. a nut, when used in conjunction with an appliance supported by teeth or adjacent static fixtures.

Dental implants are fixtures, which are commonly inserted into the jawbones in order to support dental prostheses. The fixture described herein is intended as a multipurpose anchor, which may be used to facilitate bone movement in the Osseo distraction process, as a temporary anchorage unit for Orthodontic movement of teeth, and as an anchor for dental prostheses.

Osseo Distraction

For, many reasons, there are often situations in which there is inadequate bone available in which to place fixtures. In these situations, various techniques exist which may be used to augment the available bone bulk.

Osseo-distraction (distraction Osseo-genesis) is a surgical process by which the available bone bulk may be increased. This process may be used where there is a local deficiency in jawbone height, prior to the provision of implant-stabilised prostheses. Surgery involves sectioning a segment of the jaw, which must be pedicled on the surrounding soft tissue.

Subsequently, soft tissues are allowed to heal and the bone callus to develop. However after a few days latency, the bony “transport” segment is distracted, thus stretching the healing callus. Distraction proceeds incrementally, and substantial volumes of new bone may be laid down between the transport segment and the bony jaw base.

Varied fixtures and mechanisms have been developed to facilitate this process.

Orthodontic Tooth Movement

When teeth are poorly positioned from either a cosmetic or a functional point of view, their position may be changed by the application of forces via springs or other appliances. Newtons Third Law means that a force applied to a tooth will be countered by an equal and opposite force applied to the tooth or teeth to which the spring is anchored. This limits the rate at which teeth may be moved and may complicate orthodontic treatment.

Dental implants, which are osseointegrated, form a firm, stable connection to the bone, which may not be changed by the application of orthodontic forces. This means that a dental implant may form an ideal anchor for orthodontic movement of teeth.

Provisional Anchorage of Temporary Dental Prostheses

There are many situations where it is desirable to be able to provisionally replace teeth, e.g. whilst healing takes place in future implant sites, or during the orthodontic alignment of teeth adjacent to a future implant site

A provisional implant should be easily placed, easily removed, and should provide means for the ready fixation of teeth.

This Invention Relates to a Fixture Type and Related Components, Intended to Facilitate the Distraction Process, Act as a Stable Anchorage Unit for the Connection of an Orthodontic Appliance, and which May Also Act as a Provisional Support for Temporary Restorations

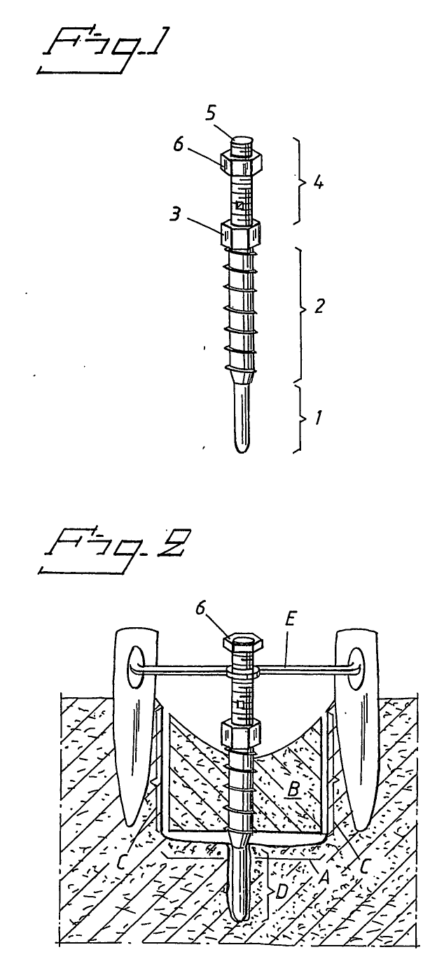

A specific embodiment will now be described: With reference to FIG. 1, there is provided a fixture, which may be made of machined titanium or a titanium alloy. The fixture may broadly be categorized as containing three segments.

An alignment section (1) is provided having a smooth surface, and as in this case a relatively small diameter. A bone interfacing (2) retentive section is provided having a deep-set steeply pitched thread on a slightly tapered base (taper exaggerated in diagram). In some situations, the surface of this section of the fixture may be roughened, or coated, e.g. with hydroxyapatite, to encourage rapid osseointegration.

A non-axially symmetrical collar (3) facilitates insertion of the device by means of a matched insertion tool, which fits over the intra oral part (4) of the fixture, rather like a socket spanner. This part is polished to allow a gingival cuff to develop around the fixture.

The intra oral part of the fixture (4) comprises a narrow extension provided with a machine screw threading, but having a single flattened side (5).

Surgery Proceeds as Follows, With Reference to FIGS. 1 & 2:

Following elevation of a surgical flap, a horizontal osteotomy is performed (A) at the base of the future transport segment (B).

Before the transport section is mobilized by the vertical osteotomies (C), a site is prepared for the distraction fixture or fixtures; having marked the site with a round burr a 1.2 mm twist drill is inserted beyond the depth of the horizontal osteotomy, such that the site is prepared in bone of good bulk and quality.

A second twist drill is then inserted into the prepared site, having a slightly greater diameter, e.g. 1.6 mm, to the depth of the horizontal osteotomy

If visibility and access to the site is unimpaired the surgeon may then continue to carry out the vertical osteotomy, thus freeing the transport section. However generally the osteotomy is only carried out to an extent, which will allow the transport segment to be easily mobilized once the fixtures have been placed.

The distraction fixture is then placed by means of an insertion tool that properly mates with the non-axially symmetrical collar such that the alignment section (1) travels through the narrowly prepared depth of the site (D). The threaded section (2) is tapped through the prepared site such that it engages the transport segment.

The threaded intra oral section (4) then protrudes into the mouth such that it is aligned with adjacent teeth or fixtures, and the main bulk of the bone is in the intended trajectory.

Following latency, typically a healing period of four-seven days, distraction may begin. For distraction to take place there may be provided either a temporary prosthesis which serves to provisionally replace the missing teeth, or a simple appliance, (E), which may take the form of a cast bar, resin reinforced structure, or orthodontic appliance anchored to adjacent teeth of fixtures.

A prosthesis or appliance may be provided with a portion through which the threaded part of the distraction implant protrudes. Distraction may then be accomplished by tightening a nut (6) onto the machined threaded section so as to pull it through the channel, thus distracting the bony segments. As the portion of the threaded section protrudes past the nut, it may be sectioned so as to avoid interference within the mouth. Once distraction has taken place to the planned extent the arrangement is left in place for a subsequent period of six-eight weeks until the transport segment has stabilised, and bone has formed in the space between the segment and the bony base.

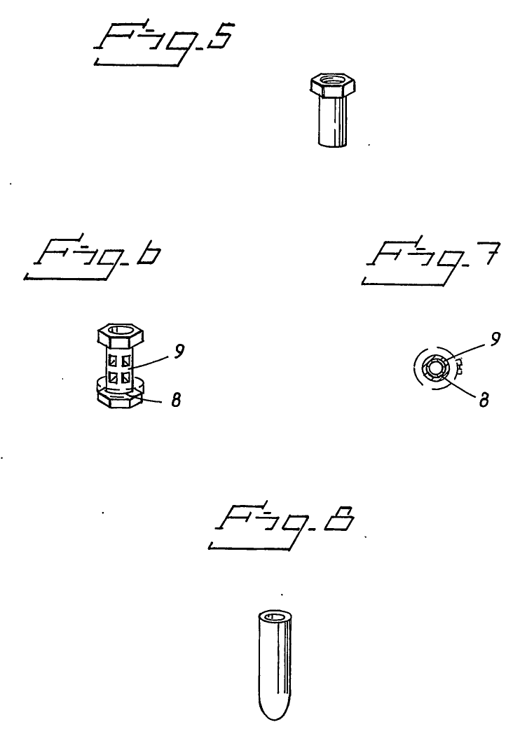

An orthodontic appliance may be fitted with a matched component, (e.g as illustrated in FIGS. 6 and 7 (cross section)), which is designed to fit onto the arch wire of a fixed appliance, and mate with the head of the distraction fixture, thus allowing the distraction process to be controlled accurately in three dimensions.

Where large distraction movements must take place, there may also be provided similar fittings having extension pieces having an internal thread, which may be rotated over the threaded head of the fixture, to extend the reach of the component.

A Further Embodiment Will Now be Presented in which Connection to a Prosthesis or Orthodontic Appliance Constrains Movement, Allowing for Simplification of the Fixture, which May Act as an Anchor for Orthodontic Procedures or Osseo Distraction:

Fixed Orthodontic appliances with e.g. Square arch wires provide excellent control over tooth movements in all dimensions. Such appliances used in conjunction with an anchor placed in the transport segment will equally permit multi dimensional control of the distraction process, without necessitating penetration of the fixture beyond the horizontal osteotomy.

FIG. 3 illustrates a fixture having a bone interfacing retentive section (2) provided with a deep-set steeply pitched thread on a slightly tapered base.

A non-axially symmetrical collar (3) facilitates insertion of the device by means of a matched insertion tool, which fits over the intra oral part (4) of the fixture, rather like a socket spanner. This part is polished to allow a gingival cuff to develop around the fixture.

The intra oral part of the fixture (4) comprises a narrow extension provided with a machine-screw threading, but having a single flattened side (5).

Towards the middle of the intra oral part of the fixture there is provided a square or rectangular aperture (6).

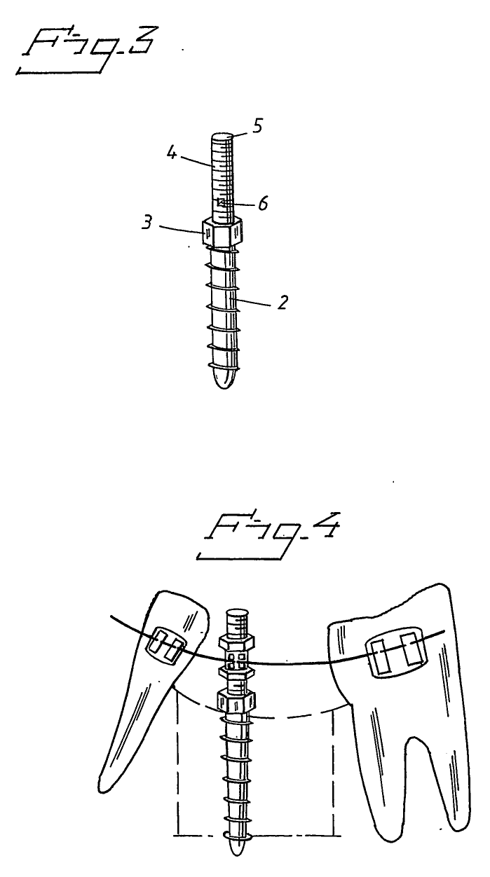

A cylindrical Orthodontic fitting (FIG. 5) is provide having a matched internally threaded section which my be rotated over the threaded intra oral part of the fixture, to a varying degree by means of a spanner. At least one aspect of this fitting has a surface conducive to dental bonding materials, which will permit bonding of an orthodontic bracket.

Alternatively, a similar fitting may be provided, without internal threading, intended for direct cementation, additional stability being provided by the flattened side (FIG. 8).

For distraction purposes, a variation on the orthodontic fitting described above may be provided (FIGS. 6 and 7), having a freely rotating bush (9) around its body (8), to which an orthodontic bracket may be attached.

Construction of Laboratory-made prostheses or appliances may also be facilitated by provision of impression copings of matched dimensions, which fit over the threaded portion of the fixture, engaging the flattened side.

For the Retention of Crown and Bridge Work:

In addition to the Orthodontic and Distraction utility of the fixture, there is also the option to use such a fixture to retain crown or bridge work, for which purpose there may be provided prefabricated copings in metal alloy, or in plastic for use e.g. as a burn out or impression coping, or which may either be cemented directly over the threaded intra oral part, mating with the flattened side so as to locate accurately into position and to resist rotational forces, or alternatively be cemented or clipped into place over the Orthodontic fitting; it may in some cases be expedient to incorporate an orthodontic bracket into a temporary restoration. So as to achieve the best possible appearance for provisional restorations the prefabricated copings may engage the wider collar.

For Orthodontic or distraction movements, the fixture and the various fittings may be simply used in conjunction with a fixed orthodontic appliance. Figure (4) illustrates possible usage of the orthodontic anchor to anchor an orthodontic arch wire.

The fixtures may be placed in the same axis as the teeth or may be used horizontally, in which case the square aperture (FIG. 3, (6)) will provide useful connectivity to an appliance.

Connection of the Orthodontic or distraction fitting to the intra oral part of the fixture permits the fixture to be linked to an appliance, either to provide anchorage for orthodontic movements or to stabilize the transport segment of bone during distraction.

Movement of teeth or Osseo distraction may be achieved in every dimension by varying the position of the fitting on the fixture, changing the relative position of the orthodontic brackets, or by changes in the shape of the orthodontic arch wire.

Surface Considerations for the Provisional Fixture

Although a fixture having a conventional milled surface may achieve good initial stability in a well-prepared site in bone of reasonable quality, the stability of the fixture may be less than ideal in soft bone, or in a poorly prepared site, and may suffer further if the fixture is rapidly subjected to heavy loading, before osseointegration has had time to develop.

Dental implants have been developed with various types of “rough” surfaces, which will increase the rate of bony integration of the fixture. It has been shown that titanium or titanium alloy fixtures having such surface treatments, e.g. plasma spraying, sand blasting, acid etching, hydroxy apatitite coatings or titanium dioxide coatings will integrate more rapidly, so that the fixture may be more rapidly loaded.

It has also been established that fixtures having rough surfaces which may be exposed to the oral cavity, may become affected by and be prone to inflammation of the gingival cuff (perimplantitis), as a result of rapid and persistent bacterial colonisation of the roughened surface.

In an attempt to circumvent these problems fixtures have been designed such that the surface of that part of the fixture intended to be submerged beneath bone is treated to encourage bony anchorage, whilst that part of the fixture which approximates, or may eventually approximate the gingival tissues has a smoother surface. Fixtures have been described having both incrementally, progressively, rougher surfaces towards the apex of the fixture and a smoother surface towards the gingival aspect, and also having a roughened apical portion, with a machined gingival portion, such that the most superficial screw threads have a machined surface.

When considering the temporary fixture, it is evident that early integration is extremely desirable, and that longer term bacterial colonisation less of a worry for a fixture that is intended to be used only in the short term.

However a temporary fixture with an overall surface treatment would be relatively difficult to remove if fully osseointegrated, as fixtures having rough surface treatments are extremely difficult to rotate out of the bone.

This invention relates to a fixture for temporary or provisional use, in which the apical part of the fixture has a machined, or otherwise relatively smooth surface, whilst the coronal part of the bone approximating thread has a rough surface treatment so as to encourage rapid bony integration of the fixture, particularly where the coronal threads pass through the cortex of the bony site.

Alternatively the fixture may have a surface that is progressively rougher when proceeding from apex to the gingival approximating portion.

In use the fixture may be inserted into a freshly prepared site. If initial stability is high the fixture may be rapidly loaded, and as osseointegration proceeds the stability will increase. Whilst initial stability is largely a function of the implant shape and the anatomy of the bony site, secondary stability will be greatly enhanced as a result of osseointegration, which will proceed most rapidly adjacent to the bony cortex and the treated implant surface. This is clearly all the more important when initial stability is low.

Implant Removal: Having used the implant for its intended purpose, it will then be necessary to undertalke removal, which may in some cases be achieved by simple counter rotation of the fixture to break the bony union.

This may however result in fracture of the fixture at or around the level of the bony crest.

In this case a trephine may be used to cut around the fixture. The fact that the “rough” surface treated portion of the fixture does not extend along the full length of the endosseous part of the fixture means that, removal is facilitated, as there is a reduced need to use the trephine to the full depth of the fixture, thus preserving bone in the area. Indeed removal may be accomplished by means of a matched trephine.

1. A fixture having external threading, comprising, 1/ a threaded Part for insertion into a prepared site in the jaw bone, and 2/ a threaded part, to which pressure may be applied by means of an internally threaded element, when used in conjunction with an appliance supported by teeth or adjacent static fixtures.

2. A one piece implant for osseodistraction or orthodontic anchorage, having a threaded part for insertion into bone, with the characteristics of a dental implant for insertion into bone, at one end, and the characteristics of a machine screw at the other end, which is intended to protrude into the mouth, for the connection to appliances, or prostheses, for the distraction of bone or the orthodontic movement of teeth.

3. A fixture as claimed in claim 1, having two externally threaded parts, one which is inserted into a prepared site into the jaw bone, the other which protrudes into the oral cavity so that it may be acted upon by an internally threaded components.

4. A fixture as claimed in claim 1, having an externally threaded part which protrudes into the oral cavity, said part having a flattened aspect, such that it may be acted upon either by an internally threaded component, or by cement on female components, or clip on female components, which mate with said flattened aspect to prevent rotation of the component.

5. A fixture as claimed in claim 1, having a smooth, non threaded, alignment section at w its apex, intended to guide the transport segment of bone as it the bone is distracted and prevent inappropriate movement.

6. A fixture as described in previous claims claimed in claim 1, which is provided with a polished section, intended to act as a collar to which the gingival cuff will approximate, said collar having a non round cross-section to allow insertion of the fixture with an appropriate shaped socketed tool.

7. A fixture as claimed in claim 1, wherein the fixture is designed for connection to prostheses, orthodontic appliances, or adjacent teeth or dental implants.

8. A fixture as claimed in claim 1, wherein the fixture is designed for connection to orthodontic appliances, said fixture having within its body an aperture, which may be square or rectangular, through which an orthodontic wire may be passed to facilitate connection of said fixture to adjacent teeth or appliances.

9. A fixture as claimed in claim 1, having a slightly tapered body, having deeply biting threads, on a part intended for insertion into the jaw, and a metric machine threaded on a part intended to protrude through the gingiva.

10. (canceled)

11. (canceled)

12. A fixture range or system for Osseo distraction, or for orthodontic anchorage in a jaw, having available matched components, provided with fittings to facilitate the connection of arch wires, or the cementation of orthodontic components.

13. A fixture as claimed in claim L having a surface treatment intended to encourage rapid osseointegration, wherein said surface treatment comprises plasma spray, etching, blasting, titanium dioxide, hydroxyl-apatite or other roughening processes, on only the more superficial endosseous part of the fixture which is intended to contact the bony cortex of the intended site, and a smoother, possibly machined surface towards the apical portion of the fixture.

14. A fixture as claimed in claim L having a progressively rougher surface, which is relatively smooth toward the apex of the fixture, and which becomes relatively rougher, and more attractive to bone growth towards the coronal aspect of that part of the fixture which is intended to contact the bony cortex of the intended site.

15. A range or system of components for Osseo distraction, or for orthodontic movement of teeth, provided with fittings to facilitate the connection of arch wires, or the cementation of orthodontic components, wherein said range or system of components is arranged to be used in conjunction with a fixture having an externally threaded intra oral part or a threaded and flattened intra oral part.
